(19) United States
(12) Patent Application Publication
(10) Pub. No.: US 2010/0320331 A1
(43) Pub. Date: Dec. 23, 2010

(54) Unitary, Self-Stiffened and Pivoting Composite Panel, in Particular for a Mobile Part of an Aircraft

(75) Inventor: Philippe Vallee, Saint Martin (FR)

Correspondence Address: FROST BROWN TODD, LLC, 2200 PNC CENTER, 201 E. FIFTH STREET, CINCINNATI, OH, 45202, US

(73) Assignee: SOCATA

(21) Appl. No.: 12/866,751

(22) PCT Filed: Feb. 19, 2009
(86) PCT No.: PCT/FR09/50270

§ 371 Date: Aug. 9, 2010

(30) Foreign Application Priority Data
Feb. 20, 2008 (FR) 08 51087

(51) Int. Cl. B64C 9/00; B64C 1/14; B32B 1/00

(52) U.S. Cl. 244/198; 244/129.5; 428/68

(57) ABSTRACT

The invention relates to a panel pivoting about an axis parallel to a side of the panel, which comprises a first continuous coating (1),a main structural frame of a composite stiffener (2, 3, 4, 5, 6) connected to the coating (1) and including a stiffening mesh (2, 3) with at least one pair of cross-shaped stiffeners each oriented in one of two directions, respectively, not parallel or perpendicular to the rotation axis. The two parts (3a, 3b) of each stiffener (3, 2) extending on either side of the centre of the cross are in structural continuity, and the two stiffeners (2, 3) each have an end located at one point (A, B, C) on the side of the panel parallel to the rotation axis, wherein the end is connected to a rigid member for connection to the rotation axis, the opposite end of at least one stiffener being blocked in rotation on a bearing point on the opposite side of the panel.

The present invention relates to a self-stiffened monolithic composite panel intended to pivot about an axis of rotation, notably to form a moving part of an aircraft, such as a hatch door, particularly an aircraft landing gear door, or an aircraft flap, aileron, elevon or spoiler.

In order to produce certain pivoting airplane parts, notably doors for hatches or other openings formed in the fuselage, it is known practice to use self-stiffened monolithic panels made of composite, using a rigidifiable, notably thermostable, thermosetting or thermoplastic, resin, such as an epoxy resin, strengthened by a reinforcement made of organic or inorganic, notably mineral fibers, such as carbon fibers, for example in plies of laps or woven fabrics of fibers preimpregnated with said resin, then draped and/or layered, or alternatively by liquid resin infusion or resin transfer molding using a fiber preform, by the methods known as LRI and RTM. These panels are mounted so that they can pivot about an axis of rotation parallel to one side of the panel, which comprises a continuous first composite covering, known as the outer covering, because it faces toward the outside of the airplane when the panel is in the position in which the hatch or corresponding opening is closed, and therefore constitutes part of the outer skin of the airplane, and of a main structural reinforcement arranged on the inner face of the first covering and consisting of composite stiffeners secured to this first covering as well as, sometimes, a second composite covering, which may be continuous or perforated, arranged on the stiffeners and secured to the latter and which thus constitutes a covering known as the inner covering because it faces toward the inside of the airplane in the aforementioned position of closure.

In general, in self-stiffened monolithic panels made of composite of the prior art, the main structural reinforcement consists of a plurality of stiffeners running parallel to one another on the continuous outer covering, the stiffeners having a cross section that is said to be closed, of the omega type, as described for example in FR 2 898 539. When these structural panels, which are plane or have simple or double curvatures, are used to create parts that can pivot about an axis of rotation parallel to one side of the panel, the overall shape of which in plane view is substantially polygonal, usually having at least four sides, the stiffeners are directed in a direction perpendicular to the axis of rotation, in an attempt to give the panel sufficient torsional rigidity.

In the context of aeronautical component classification, this type of panel is generally considered to be a primary structural component which means that its design has to ensure that the panel, for example used as a hatch door, is held in place on the aircraft under all conditions. What this means is that the component parts of the panel have to be relatively thick, resulting in high mass and high production costs.

The same disadvantages are displayed by self-stiffened panels made of composite prepregs, of the type described in EP 1 537 982, in which the parallel stiffeners are U-shaped connected by their bases to the inner face of the outer covering, but arranged side by side and secured to one another by their adjacent flanges using rectangular composite interface strips, leading to a high number of stiffeners and therefore also to a high mass and high cost.

WO 2007/009923 also describes a monolithic self-stiffened composite panel for an aircraft landing gear door, comprising a first skin forming the outer wall of the panel, a second skin forming part of the inner wall of the panel, and formed in a hollow shape to constitute an internal strengthening frame creating a plurality of hollow-profile stiffeners distributed about the periphery of the panel. These stiffeners have a profile of hollow cross section, for example in the shape of an omega, and essentially constitute peripheral stiffeners running, some of them, in the direction of the axis of rotation of the panel and, others, perpendicular to this direction, with also at least one transverse stiffener which also runs perpendicular to this direction of the axis of rotation.

A panel such as that has substantially the same disadvantages as those mentioned hereinabove, particularly insufficient torsional rigidity.

The problem that the invention seeks to address is that of solving the aforementioned disadvantages and of proposing a self-stiffened monolithic composite panel intended to pivot about an axis of rotation parallel to one side of the panel, the torsional rigidity of which is improved, so that the thickness of the various component parts that make up the panel can be optimized, thus reducing the overall mass of the panel accordingly, and reducing its cost of manufacture. More generally, it is an object of the invention to propose a self-stiffened monolithic composite panel of the type set out hereinabove which is better suited than those of the prior art to the various practical requirements.

To this end, the self-stiffened monolithic composite panel, according to the invention, of the type comprising a first composite covering, which is continuous, on which there is arranged a main structural reinforcement consisting of composite stiffeners secured to the first covering, is characterized in that the main structural reinforcement comprises a latticework of stiffeners comprising at least one pair of stiffeners arranged in a cross shape, and each directed in a respective one of two directions which are neither parallel nor perpendicular to said axis of rotation, the two parts of each stiffener which extend one on each side of the node at the center of said cross being in structural continuity with one another, the two stiffeners each having one end situated at a point on said side of the panel that is parallel to the axis of rotation and where said end is secured to a rigid connecting member for connecting to the axis of rotation, the opposite end of at least one of the stiffeners being prevented from rotating on an abutment on an opposite side of the panel.

Thus, the panel of the invention can be held on an articulation line, which is the axis of rotation, and prevented from rotating at said abutment, situated on the opposite side to the articulation line, and which may consist of a latch or a stop, such as a door stop, on the surrounding structure, or alternatively on the end of an operating actuator that controls the pivoting of the panel. It will be appreciated that the stiffeners of the cross or crosses of such a panel connect the hard points which form the interfaces between the panel and the surrounding structure on which the panel is mounted such that it can pivot, these hard points corresponding to the articulation points (rigid connecting members connecting to the axis of rotation) and to the abutment (latch or stop or actuator).

The design of the panel according to the invention, which design is based on a latticework of stiffeners that make up most of the main structural reinforcement of the panel, on the one hand, allows all the stiffeners to be subjected to loads which are essentially in bending, so that they work in torsion very little if at all, and, on the other hand, allows those portions of the first covering which are delineated between the stiffeners of the main structural reinforcement to be considered as potentially justifiable without any damage tolerance criteria, thus allowing them to be engineered as such, allowing a weight saving, while the stiffeners which no longer work in torsion no longer necessarily need to have a closed cross section, of the omega type, this likewise resulting in significant cost and weight savings.

Advantageously, the panel also comprises peripheral composite stiffeners installed along the edges of the panel and secured to the first covering and to ends of cross-configured stiffeners, which produces a frame that further improves the rigidity of the panel, because it surrounds the latticework of stiffeners and is secured to the ends of the stiffeners of this latticework.

When the latticework comprises at least two crosses, the panel of the invention may advantageously additionally comprise at least one transverse composite stiffener, secured to the first covering, and arranged between two crosses made of stiffeners, each of the two ends of the transverse stiffener being secured to ends of two stiffeners each belonging to a respective one of two adjacent crosses, on the one hand, on said side of the panel which is parallel to the axis of rotation and, on the other hand, on an opposite side. Specifically, such a transverse stiffener also contributes to improving the rigidity of the panel.

Advantageously also, the panel of the invention may additionally comprise a second composite covering, added to the stiffeners and secured thereto, so that the stiffeners are trapped between the two coverings, which ensures the cohesion of the entire panel thus formed by affording structural continuity between stiffeners in the node regions at the center of the crosses, and at the junctions between the stiffeners of the crosses and the peripheral and/or transverse stiffeners.

For the same reason, and to afford the same advantage, the structural continuity of the stiffeners in at least one of said node regions at the center of at least one cross, but preferably of each cross, and/or at least one junction, but preferably at all the junctions, with peripheral and/or transverse stiffeners where present, may be afforded by at least one local strengthener of the gusset plate or fish plate type, made of composite or metal, held firmly against and secured to said node region.

To ensure good connection between the panel of the invention and a surrounding structure, fittings for holding the panel on such a structure at articulation points, notably latch or door stop, are advantageously anchored to the panel by fixings, of the rivet or bolt type, which can be accessed through openings in the second covering, where present, if the latter is perforated, to make maintenance inspections easier and improve any repairs that might be needed (notably the removal and re-fitting of the fittings).

Another advantageous consequence of the design of the panel of the invention is that the stiffeners may be of the open-section type, and preferably chosen from stiffeners having T-shaped, I-shaped, C-shaped, Z-shaped or U-shaped profile sections.

By way of particularly advantageous applications, which are also applications for which the panel of the invention is of particular benefit to the applicant, the panel may constitute a hatch door, notably an aircraft landing gear door, the first covering of which is an outer skin and the second covering of which is an inner and perforated skin, or alternatively, the panel of the invention may constitute an aircraft flap, aileron, elevon or spoiler, the first covering of which is a bottom skin, and the second covering of which is a continuous top skin.

However, of course, the panel of the invention is not restricted to these applications and may be used to produce other elements such as fuselage box sections and wing elements of an aircraft, particularly on account of the fact that it may be plane or domed, in one or more directions, and that the covering(s) and the stiffeners are made of a composite of well known type, using a rigidifiable resin, particularly a thermostable or thermosetting resin, such as an epoxy resin, or a thermoplastic resin, strengthened with a reinforcement of organic or inorganic fibers, particularly mineral fibers, such as carbon fibers, by implementing any one of the various methods known for achieving this.

Further advantages and features of the invention will become apparent from the description given hereinbelow by way of nonlimiting example of some exemplary embodiments which are described with reference to the attached drawings in which:

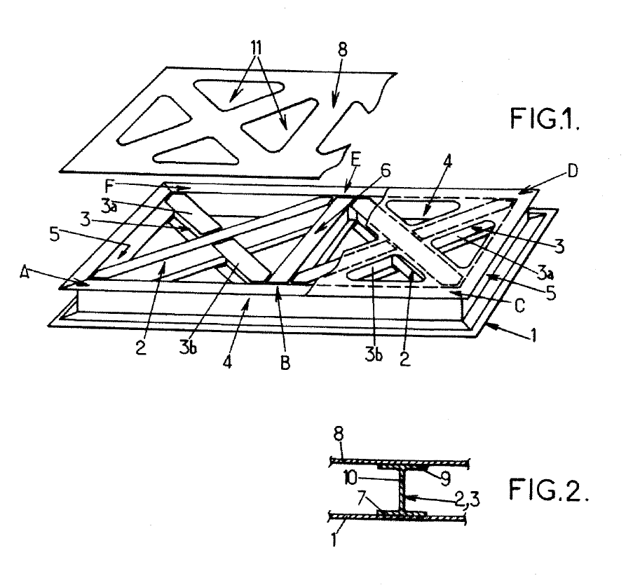

FIG. 1 is an exploded perspective view with partial cutaway of a panel according to the invention, this panel being plane and rectangular, and one that can be used for producing an airplane landing gear door;

FIG. 2 is a schematic part view in cross section of the panel of FIG. 1, at a cross-configured stiffener;

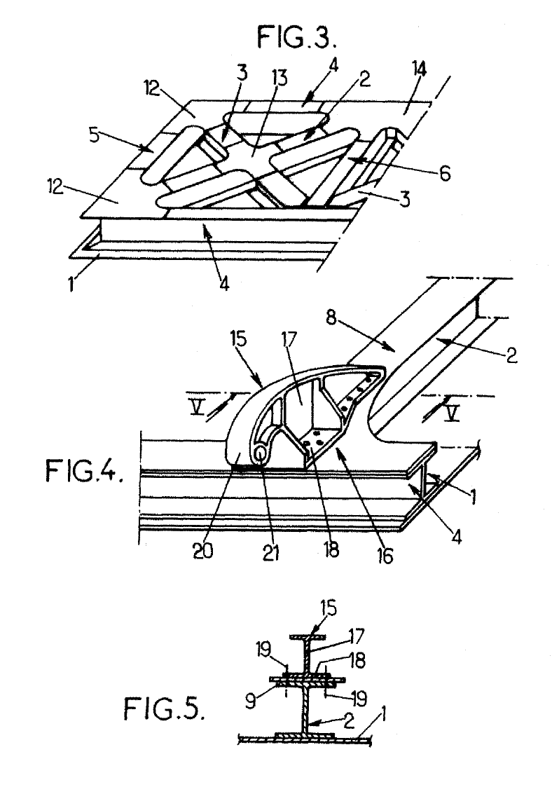

FIG. 3 is a partial perspective view of an alternative form of the panel of FIG. 1;

FIG. 4 is also a partial perspective view of a gooseneck articulation fitting mounted on a region of a junction between a stiffener of the cross-configured latticework and a peripheral stiffener of an alternative form of the panels according to FIGS. 1 and 3;

FIG. 5 is a schematic view in cross section on V-V of FIG. 4;

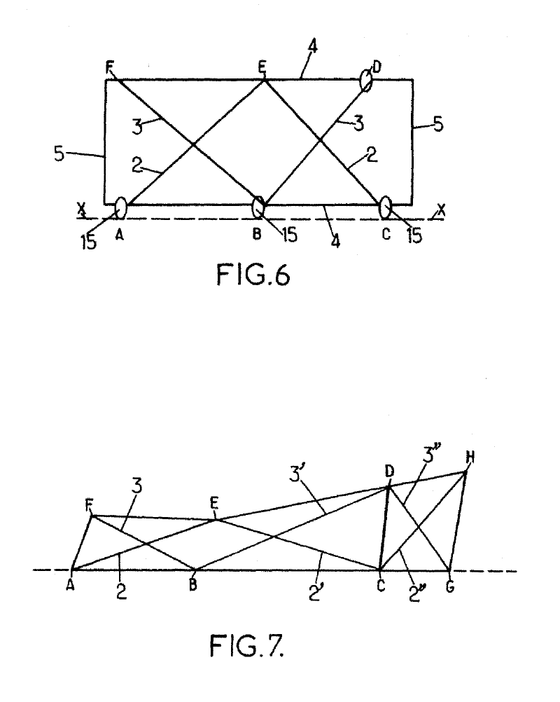

FIG. 6 is a diagram of the design of a pivoting panel according to the invention and which can be used as an airplane landing gear door; and

FIG. 7 is a view similar to FIG. 6 of a pentagonal panel that can be used as an airplane aileron, elevon or spoiler.

The self-stiffened monolithic composite panel of FIGS. 1 and 2 is plane and rectangular, and intended to pivot about an axis of rotation, not depicted, which is parallel to the long side of the panel situated in a lower position in FIG. 1, and close to and along this long side.

The panel comprises a continuous and composite covering 1 known as the outer covering because it is situated on the outside of the aircraft, in the position in which the hatch covered by the panel is closed, this outer covering 1 consisting of a layered structure of a number of plies formed of woven fabrics or laps of carbon fibers preimpregnated with an appropriate resin, for example an epoxy resin.

Arranged on the inner face of the continuous outer panel 1 is a main structure reinforcement comprising a latticework structure of two pairs of stiffeners 2 and 3 configured in a cross shape for each pair. These stiffeners 2 and 3 are straight, of I-shaped cross section and composite, and also made of a layered and/or draped structure of plies formed of woven fabrics or laps of carbon fibers preimpregnated with an appropriate resin, preferably the same resin as was used for the matrix of the composite outer covering 1. For each of the two crosses of the latticework structural reinforcement, the stiffeners 2 and 3 are each directed in a respective one of two directions which are neither parallel nor perpendicular to the axis of rotation, i.e. neither parallel nor perpendicular to the long or to the short side of the rectangular outer covering 1. In the example of FIG. 1, the stiffeners 2 and 3 are each inclined at substantially 45° to the directions of the long and short sides of the rectangular covering 1.

The main structure reinforcement also comprises four peripheral stiffeners, two of them 4 long and two of them 5 short, these running respectively along the two long and along the two short sides of the rectangular outer covering 1. These peripheral stiffeners 4 and 5 have the same I-shaped open section and the same composite structure as the cross-configured stiffeners 2 and 3. The peripheral stiffeners 4 and 5 thus constitute a rectangular frame edging the panel, and are secured to one another and to the ends of the cross-configured stiffeners 2 and 3 at the four corners of the edging frame. The structural reinforcement also comprises a transverse stiffener 6, which also has the same I-shaped open section and the same composite structure as the cross-configured stiffeners 2 and 3, and which extends from one of the two long peripheral stiffeners 4 to the other, parallel to the short peripheral stiffeners 5, between the two crosses formed by the stiffeners 2 and 3 in the edging frame of the panel. The ends of this transverse stiffener 6 are secured at once to the long peripheral stiffeners 4, to the ends of the cross-configured stiffeners 2 and 3 which are the opposite ends to the ends secured to the corners of the frame, and to the outer covering 1 to which all the stiffeners 2, 3, 4, 5 and 6 of the structural reinforcement are thus secured over the entire lower surface of the base 7 of their I-shaped profile (see FIG. 2).

The panel is supplemented by a flat and composite rectangular second covering 8, the same size as the outer covering 1, and known as the inner covering because it faces toward the inside of the aircraft when the panel, used as a landing gear door, is in the position in which the hatch is closed. This inner covering 8, which has substantially the same composite structure as the outer covering 1, is added to all the stiffeners 2, 3, 4, 5 and 6 of the structural reinforcement and secured by its outer face to the entire inner surface of the upper flanges 9 of the I-shaped profile of the stiffeners (see FIG. 2).

Thus, all the stiffeners 2, 3, 4, 5 and 6 are trapped between the two coverings 1 and 8, which ensures the cohesion of the entire panel thus formed, with structural continuity afforded between the two parts such as 3a and 3b of each cross-configured stiffener such as 3 which extend on each side of the node at the center of each cross, and in the regions at which the ends of the cross-configured stiffeners 2 and 3 connect to the ends of the peripheral stiffeners 4 and 5 (at A, C, D and F) or to the ends of the transverse stiffener 6 and the long peripheral stiffeners 4 (at B and E), by virtue of the fact that the two, outer 1 and inner 8, coverings are secured to these stiffeners.

The panel thus created is therefore monolithic and self-stiffened and has excellent torsional rigidity, allowing the thicknesses of the coverings 1 and 8, and of the base 7, of the upper flange 9 and of the web 10 of each of the nine stiffeners used to be optimized so as to reduce the overall mass appreciably.

This mass can be further reduced by creating perforations 11 in the inner covering 8, in those regions of this covering 8 which do not lie directly in vertical alignment with the peripheral stiffeners 4 and 5, cross-configured stiffeners 2 and 3, and transverse stiffener 6, so that these perforations 11 may be in the form of a triangle with rounded vertices as visible in FIG. 1, the regions between adjacent perforations and the regions around the edge of the inner covering 8 being of a width such that the upper flanges 9 of all the stiffeners are completely covered and hidden by the inner covering 8.

For use as a landing gear door, the panel may be equipped with at least two, but preferably with three, fittings for pivoting articulation about the axis of rotation, these fittings not being depicted in FIG. 1 but, for example, like the one depicted in FIG. 4 and described hereinbelow. Each of these three articulation fittings is fixed to a respective one of three hard points that provide the interface between the hatch door and the surrounding structure on which this door is mounted, these three hard points corresponding to the two node regions A and C where the axis-of-rotation end of the stiffeners 2 is secured, in one corner of the edging frame, to one end of the axis-of-rotation side peripheral stiffener 4 and to one end of a respective one of the two peripheral stiffeners 5, while the third hard point that accommodates an articulation fitting corresponds to the node region B where the axis-of-rotation ends of the two stiffeners 3 are secured both to the axis-of-rotation end of the transverse stiffener 6 and to the axis-of-rotation side of the long peripheral stiffener 4.

A fourth hard point, corresponding to the node region E, where the opposite end of the transverse stiffener 6 is secured to the ends of the stiffeners 2 and to the other long peripheral stiffener 4, or to the node region D, in a corner of the frame where one end of a stiffener 3 is secured to the same other long peripheral stiffener 4, is thus formed on the opposite side of the panel to the side closest to the axis of rotation, where it can accept a fitting or stop (again not depicted) for locking the door in the closed position against the surrounding structure, this fourth hard point (D or E) also possibly being a point of attachment of the end of the rod of a jack that operates and braces the hatch door.

Thus, the door formed by the panel is held on an articulation line which corresponds to the axis of rotation, and is prevented from rotating at a point situated on a side of the panel which is opposite to the one that runs alongside the axis of rotation.

The alternative form of panel depicted partially in FIG. 3 is depicted without an inner covering such as 8 and, for the remainder, comprises the same components as the panel of FIGS. 1 and 2, namely essentially an outer covering 1, two pairs of cross-configured stiffeners 2 and 3, four peripheral stiffeners, two of them 4 long and two of them 5 short and a transverse stiffener 6.

This alternative form in FIG. 3 essentially differs from the embodiment of FIGS. 1 and 2 in that the structural continuity of the stiffeners 2, 3, 4, 5 and 6 in the node regions, at the center of the crosses and at the junction between the cross-configured stiffeners 2 and 3 and the peripheral stiffeners 4 and 5 and the transverse stiffener 6, is afforded by local strengtheners 12 in the form of three-branch corner pieces, 13 in the shape of crosses and 14 in the shape of five-branch plates, positioned respectively on a corner of the edging frame and an end of the stiffener 2 or 3 attached to this corner, on the center of a cross formed by two stiffeners 2 and 3, and on the region in the middle of a long peripheral stiffener 4 to which one end of the transverse stiffener 6 and the corresponding ends of the stiffeners 2 or 3 are attached. These local strengtheners 12, 13 and 14 may be gusset plates or fish plates made of metal pressed firmly against and secured to the corresponding parts of the stiffeners but, for preference, these strengtheners 12, 13 and 14 are composite gusset plates or fish plates, likewise formed by the superposition of a number of laps of carbon fiber preimpregnated with epoxy resin (or with other thermostable, thermosetting or thermoplastic resins), the entity thus formed either being covered with a perforated inner covering such as 8 in FIGS. 1 and 2, or remaining uncovered.

The fittings which hold the panel on the surrounding structure, such as articulation fittings at the three articulation points A, B, C as specified hereinabove (or at least at two points A and C if just two articulation fittings are used for connecting to the axis of rotation) along a long peripheral stiffener 4 of the panel of FIGS. 1 and 2, or the latch or door stop fitting with which a hard point (D or E) is equipped on the opposite side of the panel, are fittings which are anchored onto the panel constituting a one-piece rigid structure by fixings involving bolts or rivets, as depicted schematically in the case of an articulation fitting in FIG. 4.

In this FIG. 4, the articulation fitting 15 is fixed to a node region 16 corresponding to the junction between a cross-configured stiffener 2 and a long peripheral stiffener 4, both secured to the inner face of the outer covering 1. In this node region 16, the junction between the two stiffeners 2 and 4 is also covered by part of a perforated inner covering 8, the I-sections of the stiffeners 2 and 4 and their composite structure and that of the coverings 1 and 8 being essentially identical to those of the analogous components in the examples of panels described hereinabove. The articulation fitting 15 comprises a mount 17 again of I-shaped cross section (see FIGS. 4 and 5), which is fixed by its base 18 to the node region 16 by bolts or rivets depicted schematically as 19 in FIG. 5 which represents their axis of fastening, and which fix the base 18 of the fitting 15 to the upper flange such as 9 of the stiffener 2 and of the stiffener 4, through part of the inner covering 8. The mount 17 of the fitting 15 is extended, protruding beyond the outer lateral edge of the peripheral stiffener 4 and, possibly even, beyond the outer covering 1, in the form of a neck 20 through which there passes a cylindrical bore 21 intended to accept the axis of rotation, possibly in the form of a hinge pin fitting into the hinge leaf formed by the neck 20, the bore 21 of which is coaxial with that of the other identical or analogous fittings 15 fixed to the panel at the other hard pivot points.

It will be noted that access to the fixings 19 can be had through openings or perforations made in the inner covering 8, these openings or perforations also making maintenance inspections easier and likewise improving the repairability of the door, notably through the removal and re-fitting of the fittings 15.

The design set out hereinabove for the self-stiffened monolithic composite panel according to the invention, which is based on a latticework of stiffeners 2, 3, supplemented by stiffeners 4, 5 and 6, that the main structural reinforcement of the panel comprises allows the outer covering portions 1 which are not directly covered by any of the aforementioned stiffeners to be considered as secondary structure elements according to the classification of aeronautical components, and which can therefore be damaged or even lost without affecting the structural integrity of the main latticework of stiffeners 2 and 3, and therefore without endangering the safe flight of the aircraft.

As a result, these portions of the outer covering 1 which are delineated between the stiffeners 2, 3, 4, 5 and 6 of the main structural reinforcement can be considered to be of secondary structural class and therefore engineered as such, allowing an additional weight saving.

The idea underlying the design of the panel of the invention can be explained using FIG. 6 which very schematically and in plan depicts a panel like that of FIGS. 1 and 2, except that it has no transverse stiffener 6, the depiction of this panel being restricted to that of its main structural reinforcement comprising a latticework of stiffeners configured as two crosses, like that of the panel of FIG. 1, such that the same numerical references are used in FIG. 6 to denote components analogous to those of FIG. 1, the two coverings 1 and 8 not having been depicted.

In FIG. 6, the axis X-X represents the axis of rotation parallel to a long peripheral stiffener 4 and close thereto, which constitutes a rectangular frame with the two short peripheral stiffeners 5 and the other long peripheral stiffener 4, the reinforcement latticework comprising two crosses each of which is made up of a stiffener 2 crossed with a stiffener 3.

As in FIG. 1, the hard points at which the rigid articulation members such as the gooseneck fittings 15 are fixed are identified at points A, B and C, where the cross-configured stiffeners 2 and 3 are secured by their ends to the axis-of-rotation X-X side peripheral stiffener 4 while the points D, E and F, one of which supports a door stopping or latch stop fitting, represent the hard points at which the ends of the cross-configured stiffeners 2 and 3 are secured to the other long peripheral stiffener 4 and, in addition, to a short peripheral stiffener 5, in the case of points D and F and A and C, and to a transverse stiffener such as 6 in FIG. 1 in the case of the points B and E.

The idea underlying the invention is to position a stiffener such as 3 or two stiffeners such as 2, leading from a hard point on the opposite side to the axis X-X and corresponding to the position of a door stop or latch, and therefore starting from the point D or from the point E respectively, this stiffener 3 or these stiffeners 2 extending as far as a point B or points A and C on the axis-of-articulation X-X edge of the panel without this point B or, respectively, these points A and C, lying on a perpendicular to the axis of rotation X-X passing through the point D or the point E respectively.

Next, one or more stiffeners 2 or 3 are placed against the stiffeners 3 or 2 respectively, starting from the articulation points such as B and C to hold the opposite and remaining corners of the panel.

A configuration such as this holds in place the edging stiffeners 4 and 5 and the stops or guides needed for the correct positioning of the door in relation to the surrounding structure.

All the stiffeners are thus subjected to loads in bending, and no longer work in torsion. There is therefore no longer any need to use stiffeners of closed section of the omega type. The stiffeners can be manufactured with an open section which is not restricted to an I-shape but may be of a T-shape, C-shape, Z-shape or some other shape.

By way of example, if the door latch is positioned at the point D in FIG. 6, the stiffener 3 between B and D supports the stiffener 2 between C and E, while the stiffener 2 between E and A supports the stiffener 3 between B and F.

By contrast, if the door latch is positioned at point E, the stiffener 2 between A and E supports the stiffener 3 between B and F, and the stiffener 2 between E and C supports the other stiffener 3 between D and B.

This principle of equilibrium of the door can be applied to other moving parts that pivot on an airplane, and the structure of which may be that of a self-stiffened monolithic composite panel, such as an aileron, an elevon or a spoiler.

In this case, such a pivoting part may have the schematic plan-view shape of FIG. 7, that is to say that of an elongate pentagon having a straight long side AG, which is horizontal in FIG. 7, to the ends A and G of which there are connected two short sides AF and GH, of different lengths and at different angles of inclination with respect to AG, and the ends F, H of which are connected by two sides FE and EH, which lie opposite AG, of unequal length, and inclined with respect to one another, one of them, FE, the shorter one lying to the left in FIG. 7, being substantially parallel to AG and of a length similar to that of AB. This pentagon may be defined by the edges of two coverings such as 1 and 8 in FIG. 1, but both continuous, one of which constitutes a bottom skin and the other a top skin of the wing element thus produced (aileron, elevon or spoiler). This pentagon may also be defined by a frame produced with five peripheral stiffeners supported by a three-cross latticework reinforcement with each cross consisting of a pair of cross-configured stiffeners 2, 3 or 2′, 3′ or 2″, 3″, the lengths and angles of inclination of which can vary and which, in the case of each cross, run in a respective one of two directions which are neither perpendicular nor parallel to the axis of articulation which, in this example, is parallel to AG or coincides with AG.

As FIG. 7 shows, the cross-configured stiffeners (2, 3), (2′, 3′), (2″, 3″) may be positioned on any type of surface, provided that at least one arbitrary section, such as the section CD for example, is immobilized or prevented from rotating by a jack, a stop or a catch, or in any other way. The angles of the crosses formed by the stiffeners are defined by the geometry of the panel and may be irregular. The line of articulation corresponding to the segment AG may consist of a continuous anchor line or several anchor points such as A, B, C and G, irrespective of the number of these. Furthermore, the panel is not necessarily plane, and may have various complex shapes. In particular, when the panel is an aileron, an elevon or a spoiler, it may have a curved or biconvex, symmetric or asymmetric aerodynamic profile and may also potentially have a law governing its degree of twist in relation to span, that is to say along the length of the panel. In such applications, the two composite coverings of the moving part are continuous skins, one of them the bottom skin and the other the top skin.

1. A self-stiffened monolithic composite panel, for pivoting about an axis of rotation parallel to a first side of said panel, comprising a first composite covering, which is continuous, on which there is arranged a main structural reinforcement consisting of composite stiffeners secured to said first covering, wherein said main structural reinforcement comprises a latticework of stiffeners comprising at least one pair of stiffeners arranged in a cross shape, and each directed in a respective one of two directions which are neither parallel nor perpendicular to said axis of rotation, each stiffener of said at least one pair having two parts which extend one on each side of a node at the center of said cross and which are in structural continuity with one another, each stiffener of said at least one pair having one end situated at a point on said first side of the panel and where said one end is secured to a rigid connecting member for connecting to said axis of rotation, an opposite end of at least one stiffener being prevented from rotating on an abutment on a second side of the panel, which second side is opposite to said first side.

2. The panel as claimed in claim 1, comprising peripheral composite stiffeners installed along edges of said panel and secured to said first covering and to ends of cross-configured stiffeners.

3. The panel as claimed in claim 1, comprising at least one transverse composite stiffener, secured to said first covering, and arranged between two pairs of cross-configured stiffeners, said transverse stiffener having two ends each of which being secured to ends of two stiffeners each belonging to a respective one of two adjacent crosses, on the one hand, on said first side of said the panel and, on the other hand, on a side which is opposite to said first side.

4. The panel as claimed in claim 1, additionally comprising a second composite covering, added to said stiffeners and secured thereto, so that said stiffeners are trapped between said two coverings.

5. The panel as claimed in claim 1, wherein said structural continuity of stiffeners in at least one node region at the center of at least one cross and/or at least one junction with peripheral and/or transverse stiffeners, is afforded by at least one local strengthener, held firmly against and secured to said at least one node region.

6. The panel as claimed in claim 1, wherein fittings for holding said panel on a surrounding structure at articulation points are anchored to the panel by fixings.

7. The panel as claimed in claim 1, wherein said stiffeners are of the open-section type.

8. The panel as claimed in claim 4, wherein it constitutes a hatch door, the first covering of which is an outer skin and the second covering of which is an inner and perforated skin.

9. The panel as claimed in claim 4, wherein it constitutes an aircraft flap, aileron, elevon or spoiler, the first covering of which is a bottom skin, and the second covering of which is a continuous top skin.

10. The panel as claimed in claim 1, wherein said first covering(s) and said stiffeners are made of composite using at least one of a rigidifiable, thermosetting, thermoplastic and thermostable resins, strengthened with a reinforcement of organic or inorganic fibers.

11. The panel as claimed in claim 5, wherein said at least one local strengthener is one of the gusset plate and fish plate type.

12. The panel as claimed in claim 5, wherein said at least one local strengthener is made of composite or metal.

13. The panel as claimed in claim 6, wherein said fixings are accessed through openings in a second composite covering added to said stiffeners and secured thereto.

14. The panel as claimed in claim 6, wherein said fixings are of the rivet or bolt type.

15. The panel as claimed in claim 7, wherein said stiffeners of said open-section type are chosen from stiffeners having one of T-shaped, I-shaped, C-shaped, Z-shaped and U-shaped profile sections.
